(19) United States
(12) Patent Application Publication
(10) Pub. No.: US 2004/0085923 A1
(43) Pub. Date: May 6, 2004

(54) Method and apparatus for cell reselection within a communications system

(75) Inventors: Kamran Arif Qazi, Arilington Heights, IL (US); Pramod Karnam, Palatine, IL (US); Trang Nguyen, Schaumburg, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/285,882

(22) Filed: Nov. 1, 2002

(51) Int. Cl. H04Q 7/00

(52) U.S. Cl. 370/328

(57) ABSTRACT

A method and apparatus for transferring communication within a communications system. A target cell is identified to which to transfer communication from the RU. A cell reselection request to the target cell is then initiated for requesting transfer of RU communication from the source cell to the target cell. The RU disconnects from the serving cell and any data from the SGSN to the RU is buffered by the serving PCU. The serving PCU and the target PCU detect the occurrence of the cell change prior to the SGSN detecting the cell change. As a result, the buffered data is transferred from the serving PCU to the target PCU prior to the network detecting the cell change and prior to a FLUSH-LL message being transmitted from the SGSN to the serving PCU.

### FIELD OF THE INVENTION

The present invention relates generally to cellular communication systems and, more particularly, to transferring a remote unit's communication among cells within such cellular communication system.

### BACKGROUND OF THE INVENTION

Communication systems are well known and comprise many types including land mobile radio, cellular radiotelephone, personal communication systems, and other communication systems. Within a communication system, transmissions are conducted between a transmitting device and a receiving device over a communication resource, commonly referred to as a communication channel. To date, the transmissions have typically consisted of voice signals. More recently, however, there has been rapidly growing interest in carrying other forms of signals, including high-speed packetized data signals, suitable for video, audio and other high bandwidth data applications. For ease of operation and to facilitate cost effective upgrading of existing voice systems to allow for data services, it is preferable to have the data transmission capability overlay the existing voice communication capability, such that its operation is essentially transparent to the voice communication system while still utilizing the communication resources and other infrastructure of the voice communication system.

One such communication system currently available with transparent data transmission capabilities is a General Packet Radio Service (GPRS) system as described in the Global System for Mobile Communications (GSM) Technical Specification (TS) 08.18 and incorporated by reference herein. Within such a communication system, a GSM communication system is overlaid with a GPRS communication system. In contrast to GSM's service model, which offers telephony on demand, GPRS's service model offers a wireless Wide Area Network (WAN) supporting a wide range of applications such as low-volume intermittent telemetry, video, web browsing, and the transfer of large amounts of data.

In such a system, as the remote unit's location, RF conditions or congestion level deteriorate, the remote unit (RU) may experience better radio conditions or congestion level from a neighboring cell. At that point, the GPRS network or the RU may perform a cell reselection. In GPRS networks, cell reselection may occur as often as every fifteen seconds. During cell reselection, the RU terminates the temporary block flow (TBF) from its current source cell and reestablishes the connection after a period of approximately two to three seconds at the neighboring target cell. During this period, the RU is unable to receive any downlink data and does not maintain any contact with the core network. Hence, the downlink data from the network is significantly delayed from reaching the remote unit each time cell reselection occurs.

### BRIEF DESCRIPTION OF THE DRAWINGS

FIG. 1 is a block diagram of a communication system in accordance with an embodiment of the present invention.

FIG. 2 illustrates a prior art method of cell reselection in the communication system of FIG. 1.

FIG. 3 illustrates a method of a cell reselection operation of the communication system of FIG. 1 in accordance with an embodiment of the present invention.

### DETAILED DESCRIPTION

In order to address the need for a faster cell reselection procedure and others, transferring communication within a communication system occurs as follows: during communication with a serving base station, in order to shorten the duration before downlink data can be initiated to a RU that has performed cell reselection, a cell change detection scheme is executed for enabling buffered data to be sent to the RU earlier than is done in currently available systems. The cell change detection procedure is achieved by implementing a mechanism at the PCU such that at the time when the RU establishes an uplink TBF in the new cell, the PCU proactively detects the cell change prior to the SGSN detecting the cell change. The PCU transfers the buffered data from the old cell to the new serving cell for the RU before receiving a FLUSH-LL message, or any message indicating that data transfer is to begin, from the SGSN. Accordingly, the PCU is able to transmit the buffered data relatively early to the RU over the air interface and also reduce the risk of buffer overflow within the PCU. Advantageously, the gap in the downlink data path is reduced and overall data throughput is increased.

The present invention includes a method for transferring communication within a communication system. The method identifies a target cell to which to transfer communication from the RU. A cell reselection request to the target cell is then initiated for requesting transfer of RU communication from the source cell to the target cell. The RU then disconnects from the serving cell and any data from the SGSN to the RU is buffered by the serving PCU. The serving PCU and the target PCU detect the occurrence of the cell change prior to the SGSN detecting the cell change. As a result, the buffered data is transferred from the serving PCU to the target PCU prior to the FLUSH-LL message being transmitted from the SGSN to the serving PCU. This results in significantly reducing the time for the downlink data to arrive at the RU.

The present invention further encompasses an apparatus for transferring communication within a communication system. The apparatus includes a packet control unit (PCU) for controlling communicating between a base station and a RU. In a particular embodiment a target PCU is provided for controlling communicating between a target base station and an RU and a source PCU is provided for controlling communicating between a source base station and the RU. The source PCU also is configured to buffer incoming data during the cell reselection procedure. The source PCU and the target PCU are configured such that they both are able to detect a cell change prior to the SGSN detecting the cell change. Further, the source PCU and the target PCU are configured to transmit the buffered data from the source PCU to the target PCU prior to the SGSN sending a FLUSH-LL message to the source PCU. It is to be noted that the source and target PCUs are not required to be physically separate entities. For example, the source and target cells may be handled by the same PCU.

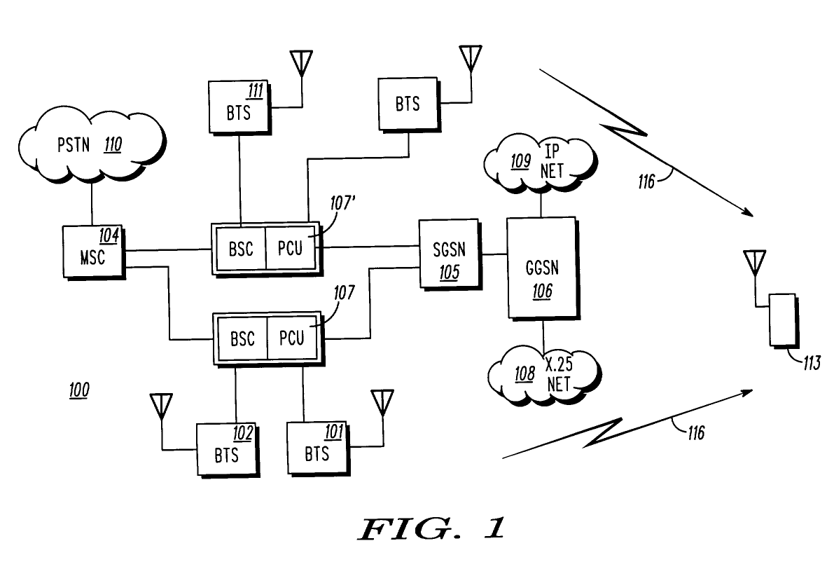

Turning now to the drawings, FIG. 1 shows a block diagram of communication system 100 in accordance with the preferred embodiment of the present invention. In the preferred embodiment, communication system 100 comprises a GSM system overlaid with a GPRS system. In other embodiments, communication system 100 utilizes other analog or digital cellular communication system protocols such as, but not limited to, Narrowband Advanced Mobile Phone Service (NAMPS) protocol, Advanced Mobile Phone Service (AMPS) protocol, Code Division Multiple Access (CDMA) system protocol, Personal Digital Cellular (PDC) protocol, United States Digital Cellular (USDC) protocol, or Cellular Digital Packet Data (CDPD) protocol.

The GSM system comprises a number of network elements including a serving Base Transceiver Station (BTS) 101, neighboring BTSs 102, 111, a Base Station Controller (BSC) 103, and a Mobile Switching Center (MSC) 104. The GPRS system network elements include the serving BTS 101, the neighboring BTSs 102, 111, the BSC 103, a Packet Control Unit (PCU) 107, a Serving GPRS Support Node (SGSN) 105, and a Gateway GPRS Support Node (GGSN) 106. In the described embodiment of the present invention, all network elements are available from Motorola, Inc. of Schaumburg, Ill.

The SGSN 105 controls users' access to the GPRS network in terms of subscription checking and overall traffic load situations, while the GGSN 106 is the GPRS equivalent to a gateway function, which connects the GPRS network to external private or public networks 108-109. It is contemplated that network elements within the communication system 100 are configured in well known manners with processors, memories, instruction sets, and the like, which function in any suitable manner to perform the function set forth herein.

During typical operation, the RU 113 moves throughout a coverage area of the serving base station 101 and the serving base station 101 monitors a signal quality metric (e.g., RXLEV or received Bit Error Rate (BER)) of the RU's uplink communication signal. Additionally, the RU 113 monitors a signal quality metric of the neighboring base stations and reports the result to the serving base station. To account for changes in signal quality as the RU 113 moves throughout the communication system 100, the base station 101 will issue commands directing the RU 113 to handover to a base station that can better serve the RU 113 (e.g., neighboring base station 102).

In a particular embodiment of the present invention, the communication system comprises a set of neighboring base stations (e.g., base station 102) that are capable of supporting the service requirements of the RU 113. The RU 113 performs signal quality measurements of transmissions from all the base stations. When the serving base station 101 determines that a handover of RU 113 is needed, the base station 101 sends handover instructions to the RU 113 via the downlink communication signal 116, which instructs the RU 113 to handover to a neighboring base station that can best serve the RU 113. Alternatively, the RU 113 may independently decide to execute a cell reselection procedure through a process commonly referred to as “mobile initiated cell reselection”. Advantageously, the present invention operates equally well in both scenarios, such as where cell reselection is initiated either by the network or by the RU.

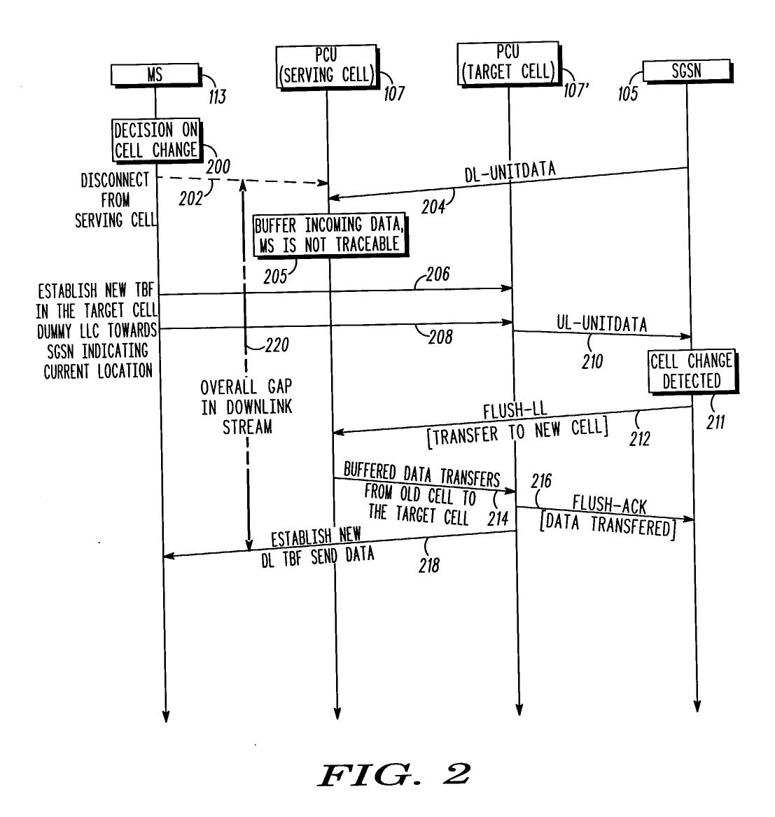

In presently available GPRS systems, downlink data from the target PCU to the source PCU is blocked until the SGSN detects a cell change and signals the PCU to transfer buffered data from the source PCU to the target PCU. For example, referring to FIG. 2, there is illustrated a prior art system of cell reselection.

As shown in FIG. 2, upon deciding to execute a cell change procedure in step 200, the RU disconnects from the serving or source cell or PCU 107 in step 202 by ending the TBF. Shortly thereafter, the RU 113 reestablishes the connection to the network in a new cell or target PCU 107′ by establishing a new TBF. During the time the RU 113 is disconnected from the network in step 205 the network buffers any incoming downlink data in the DL-UNITDATA message 204 that may be transmitted by the SGSN 105 in step 204.

When the RU appears in the target PCU 107′, the RU 113 establishes an uplink TBF in step 206 and signals the SGSN with its current location by sending in step 208 either a real (if available) or dummy LLC to the SGSN 105 via the target PCU 107′. The SGSN 105 in step 211 detects the cell change and in step 212 signals the source PCU 107 with a FLUSH-LL message 212 instructing the source PCU 107 to transfer any buffered data from the old source PCU 107 to the target PCU 107′. It is to be noted that until the source PCU 107 receives the FLUSH-LL message 212, the downlink stream remains blocked. A particular disadvantage of such a procedure is that the RU 113, although available in the target cell 107′, wastes time waiting for the buffered downlink data to arrive from the old cell 107. Finally, in step 214 the source PCU 107 transmits the buffered data from the old source PCU 107 to the target PCU 107′. In step 216 the target PCU 107′ sends a FLUSH-LL-ACK message 216 to the SGSN 105 acknowledging that the buffered data has been transferred. Finally, the target PCU 107′ sends a message to establish DL TBF 218 to the RU 113 over which to send data. Unfortunately, the overall gap 220 in the downlink data stream is fairly substantial and may be in the range of hundreds of milliseconds and possibly greater under heavy load conditions.

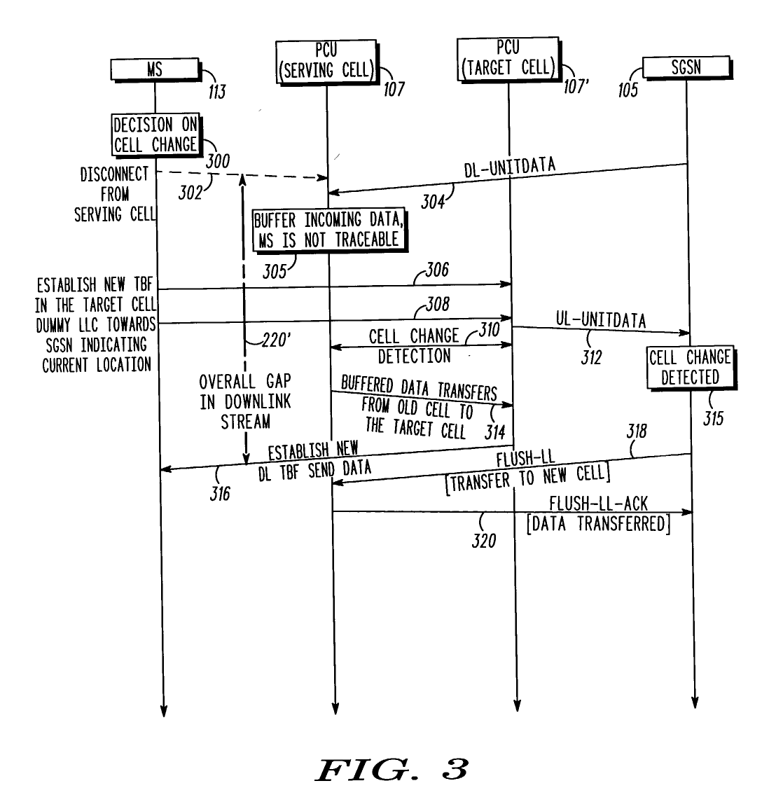

Turning now to FIG. 3, there is shown a cell reselection procedure that shortens the gap in the downlink datapath during cell reselection. This is done by executing a cell change detection scheme within the PCU and initiating data transfer prior to the network acknowledging the cell change.

In particular, when the RU establishes an uplink TBF in a new cell, the PCU proactively detects a cell change. The PCU starts to transfer the buffered data from the old cell to the new serving cell for the RU prior to receiving a Flush-LL message from the SGSN. This enables the PCU to start transmitting the buffered data early to the RU over the air interface. Advantageously, this results in a reduced risk of buffer overflow within the serving PCU. The result is an overall shortening of the gap in the downlink data path and increased throughput performance. A particular advantage of the system is its ability to stay within the conformance limits of existing standards.

In operation, in step 300, the RU 113 decides to execute a cell change. As such, the RU 113 disconnects from the serving cell PCU 107 by ending the TBF. Because the network is not aware yet of the cell change, the SGSN, at the same time, or shortly thereafter, may send a DL-UNITDATA message 304 to the serving cell PCU 107. Because the RU 113 is not traceable at this point, any data carried by the DL-UNITDATA message is buffered in step 305 by the serving cell PCU 107.

Shortly after the RU disconnects from the serving PCU 107, the RU 113 establishes a connection with the target PCU 107′ by sending a TBF message 306 to the target PCU 107′. Next, the RU 113 transmits either a real or dummy LLC message 308 towards the SGSN 105 indicating its current location. A cell change message 310 is then transmitted between the serving cell PCU 107 and the target PCU 107′ confirming to both PCU's that the cell change has occurred. Once again, this exchange occurs prior to the network detecting the cell change. Subsequently, the target PCU 107′ transmits a UL-UNITDATA message 312 to the SGSN 105 and the network becomes aware of the cell change in step 315.

Typically, in known systems, after the SGSN 105 detects the cell change, a Flush-LL message is sent prior to transfer of the buffered data to the target PCU as shown above in FIG. 2. In contrast, however, in the system of the present invention, the serving cell PCU 107 transfers the buffered data to the target cell PCU 107′ substantially in parallel with the SGSN 107 detecting the cell change. Further, the target PCU 107′ establishes a connection with the RU 113 by transmitting a DL TBF message to the RU 113. Preferably, as shown, the data transfer and the establishment of the DL-TBF occurs prior to the SGSN 107 transmitting a Flush-LL message 318 to the serving cell PCU 107. Thus, the system is not required to waste valuable time in waiting on the SGSN to recognize the cell change.

The PCU 107 receives the Flush-LL message from the SGSN 105, which is intended to instruct the PCU 107 to transfer data to the target cell PCU 107′. Because the data had been previously transferred from the target cell, the serving cell PCU 107 is able to immediately inform the SGSN 105 that the data has been transferred by transmitting a Flush-LL-ACK message 320 to the SGSN 105.

Thus, it can be seen that by the PCU proactively monitoring for a cell change and immediately starting data transfer from the serving cell PCU 107 to the target cell PCU 107′, the time required in waiting for and responding to protocol messages is significantly reduced, thereby resulting in a significantly faster cell reselection process.

Although the present invention has been described with reference to certain embodiments, numerous modifications and variations can be made by those skilled in the art without departing from the novel spirit and scope of the present invention.

What is claimed is:

1. A method for transferring communication within a communications system, the method comprising the steps of:
identifying a target cell to which to transfer communication from a remote unit, wherein the remote unit is in communication with a source cell;
submitting a cell reselection request to the target cell for requesting transferring of remote unit communication from the source cell to the target cell;
transmitting the identity of the remote unit to the target cell; and
initiating data transfer from the source cell to the target cell prior to the communications network detecting the cell reselection.

2. The method of claim 1, wherein a PCU proactively detects that the remote unit has transferred from the source cell to the target cell.

3. The method of claim 1, wherein data transfer from the source cell to the target cell is completed prior to a message being transferred from the communications network to the serving cell indicating that data transfer is to start.

4. The method of claim 2, wherein the initiating step is started prior to the network detecting the cell change.

5. The method of claim 1, further comprising the step of establishing a downlink temporary block flow prior to the Flush-LL message being transmitted by an SGSN to the serving cell.

6. The method of claim 1, wherein both the Flush-LL message and the acknowledgement are transmitted subsequent to the start of data transfer.

7. The method of claim 1, further comprising the step of transferring downlink data arriving from the SGSN without first establishing a downlink temporary block flow.

8. The method of claim 1, further comprising the step of a serving cell PCU transferring the buffered data to a target cell PCU substantially in parallel with the SGSN detecting the cell change.

9. An apparatus for controlling cell reselection in a communication system, comprising:
a target control unit associated with a target cell for controlling communicating between a target base station and a mobile station;
an SGSN for detecting the cell reselection in the communication system;
a source control unit associated with a source cell for controlling communicating between a source base station and a remote unit, wherein the remote unit abandons communication with the source cell and establishes communication with the target cell during cell reselection, the source control unit and the target control unit configured to detect the cell reselection and in response to initiate a data transfer from the serving cell to the target cell prior to the SGSN detecting the cell reselection.

10. The apparatus of claim 9, wherein the communication system is a General Packet Radio Service (GPRS) system overlaid with a Global System for Mobile Communications (GSM) system.

11. The apparatus of claim 9, wherein the source and target control units comprise packet control units for directing data traffic in the communication system.

12. The apparatus of claim 9, further comprising at least one PCU for proactively determining that the remote unit has transferred from the source cell to the target cell.
